(19) United States
(12) Patent Application Publication
(10) Pub. No.: US 2008/0157611 A1
(43) Pub. Date: Jul. 3, 2008

(54) Vibration motor

(75) Inventor: Hyun-Seung Ki, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONIC CO., LTD., Suwon-si (KR)

(21) Appl. No.: 11/645,707

(22) Filed: Dec. 27, 2006

(30) Foreign Application Priority Data
Dec. 27, 2006 (KR) 10-2005-0130582

(51) Int. Cl. H02K 7/065

(52) U.S. Cl. 310/81; 310/43

(57) ABSTRACT

A vibration motor that includes a base and a case which form an internal space, a shaft rotatably inserted in the base and the case, a rotor inserted onto the shaft and configured to rotate, which includes multiple wound coils and a commutator connected to the wound coils, a weight attached to a lower surface of the rotor, a brush which is in contact with the commutator and which is positioned on the base, and a magnet facing the rotor, can increase vibration and reduce electrical consumption during operation.

### CROSS-REFERENCE TO RELATED APPLICATIONS

This application claims the benefit of Korean Patent Application No. 2005-0130582 filed with the Korean Intellectual Property Office on Dec. 27, 2005, the disclosure of which is incorporated herein by reference in its entirety.

### BACKGROUND

1. Technical Field

The present invention relates to a vibration motor.

2. Description of the Related Art

In general, a vibration motor generates vibration as the rotor is rotated while in an eccentric configuration, and such a vibration motor is often manufactured to have a small size for use in a mobile phone or pager, etc.

FIGS. 1 and 2 illustrate a general coin type vibration motor, where FIG. 1 is a plan view of the rotor mold portion formed as a single body with the rotor positioned on the inside upper portion of the vibration motor, and FIG. 2 is a cross-sectional view of a coin type vibration motor incorporating the cross section I-I′ of FIG. 1.

As illustrated in FIGS. 1 and 2, a shaft 105 is inserted through the upper center of a bracket 109, and a magnet 108 shaped as a donut surrounding the outer periphery of the shaft and spaced apart from the shaft 105 is installed on the upper surface of the bracket 109. Within the space encompassed by the magnet 108, brushes 111 each having a bending portion are placed in contact with the commutator board 103 located above them.

The commutator board 103 is equipped on the back surface of the rotor 102. The rotor 102 is positioned above the magnet 108 and is supported by a bearing 106 to be able to rotate about the shaft 105. On the upper surface of the rotor 102 on which the commutator board 103 is positioned, there are wound coils 107 formed separately, with a weight 113 installed between them for applying eccentricity.

The following is a description of the operation of the conventional coin type vibration motor. When power is supplied from an outside source to the vibration motor, an electric current flows through the brushes 111 and commutator board 103 to the wound coils 107 arranged in the eccentric rotor 102. Due to the interaction between the magnet 108 and the field magnet formed by the case 101, the rotor 102, which is made eccentric by the weight 113, rotates about the shaft 105 by way of the interposed bearing 106, to induce vibration.

However, as illustrated in FIG. 1, since the weight 113 is positioned on the upper portion of the rotor in a conventional coin type vibration motor, the sizes of the coils 107 cannot be increased, and thus the vibration of the motor cannot be increased either. Also, since the magnet 108 is arranged only on the bracket 109, the magnitude of the magnetic force lines passing through the coils 107 is not sufficiently large, so that the vibration of the motor cannot be increased.

### SUMMARY

A certain aspect of the invention is to provide a vibration motor which can increase the vibration of a motor and reduce the amount of electrical consumption during operation.

Another aspect of the invention is to provide a vibration motor having a rotor that can be manufactured easily.

One aspect of the invention provides a vibration motor that includes a base and a case which form an internal space, a shaft rotatably inserted in the base and the case, a rotor inserted onto the shaft and configured to rotate, which includes multiple wound coils and a commutator connected to the wound coils, a weight attached to a lower surface of the rotor, a brush which is in contact with the commutator and which is positioned on the base, and a magnet facing the rotor.

Embodiments of the vibration motor according to an aspect of the invention may include one or more of the following features. For example, the number of the wound coils may be three, with each wound coil arranged on the rotor in intervals of about 120°, where all of the wound coils may have the same size.

The weight may have a central angle smaller than 180°, and may be made of tungsten or a tungsten alloy. The shaft may be inserted in the case and the base by way of a bearing, for smoother rotation of the shaft. Also, a sliding washer may be positioned between the end of the shaft and the base for an even smoother rotation of the shaft.

The weight may have a fan-like shape, or the weight may have a horizontal cross-section shaped as an arc and may be attached along the periphery of the rotor. Also, the rotor may further comprise a hard board, and the commutator, shaft, wound coils, and weight, may be formed as a single body with the hard board by insert injection molding.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a plan view of the rotor of a conventional vibration motor.

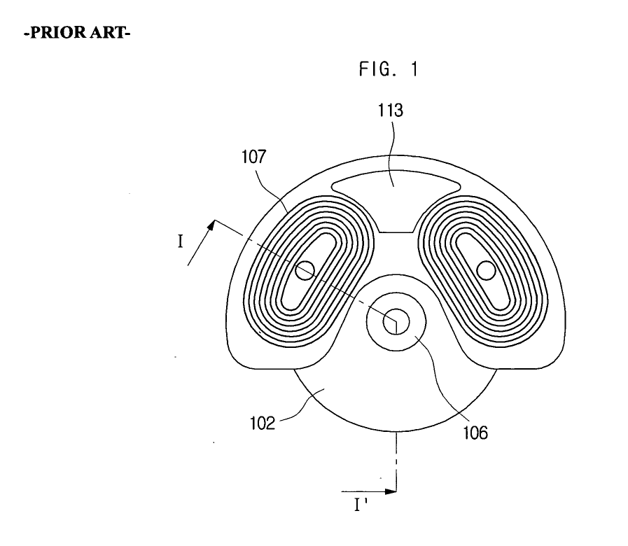

FIG. 2 is a cross-sectional view of a conventional vibration motor.

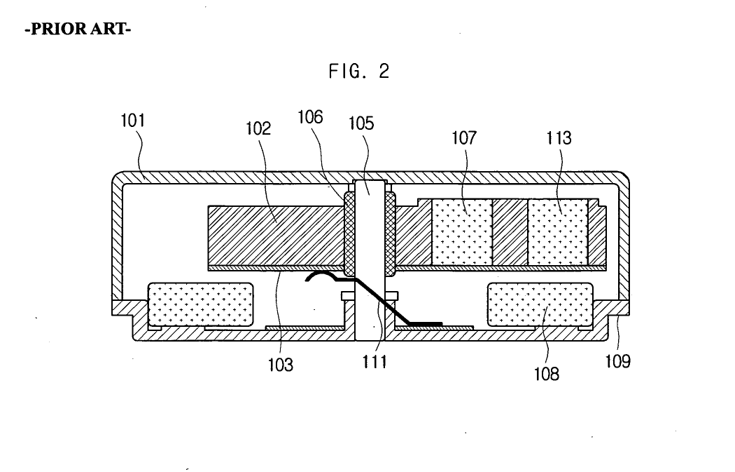

FIG. 3 is a cross-sectional view of a vibration motor according to an embodiment of the invention.

FIG. 4 is a plan view of a rotor according to an embodiment of the invention.

FIG. 5 is a plan view illustrating a weight attached on the lower surface of a rotor according to another embodiment of the invention.

### DETAILED DESCRIPTION

Embodiments of the invention will be described below in more detail with reference to the accompanying drawings. In the description with reference to the accompanying drawings, those components are rendered the same reference number that are the same or are in correspondence regardless of the figure number, and redundant explanations are omitted.

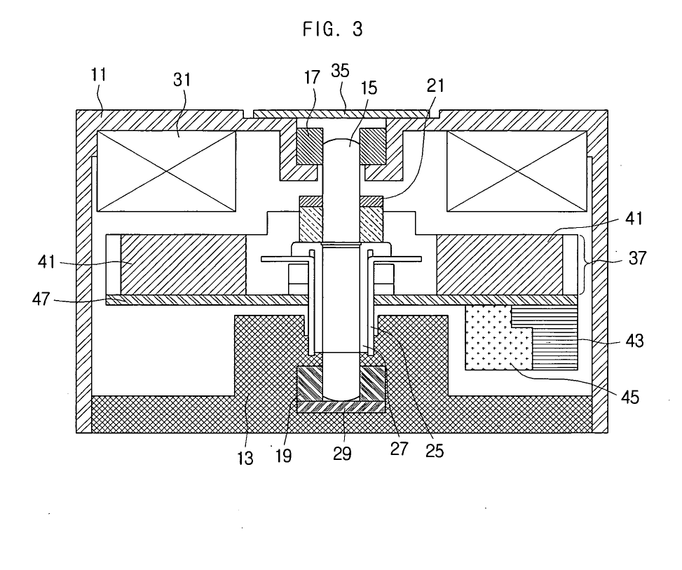

Referring to FIG. 3, a vibration motor according to an embodiment of the invention includes a base 13 and case 11 which form an internal space, a shaft 15 rotatably inserted in the base 13 and case 11, a rotor 37 which is supported by the shaft 15 and which induces vibration, a weight 43 attached to the lower surface of the rotor 37, brushes 25 which are in contact with the commutator 27 and which are positioned on the base 13, and a magnet 31 which faces the rotor 37 and which is secured to the case 11. The rotor 37 includes wound coils 41 and the weight 43, which may be secured onto a hard board 47 by a mold 45.

In the vibration motor according to this embodiment, the weight 43 is arranged at the lower surface of the rotor 37, which makes it possible to increase the sizes of the coils for greater vibration. Also, by attaching the weight 43 onto the lower surface of the rotor 37, the size of the weight 37 can be increased, to further increase the vibration. Moreover, the shaft 15, commutator 27, wound coils 41, and weight 43 may be attached onto the hard board 47 as a single body by insert injection molding, to increase productivity and improve the durability of the rotor 37.

The vibration motor according to this embodiment will now be described below in detail for each component.

The case 11 and base 13 join together to form the internal space of the vibration motor. One end of the shaft 15 is inserted in the center of the case 11 by way of an upper bearing 17, while the other end of the shaft 15 is inserted in the center of the base 13 by way of a lower bearing 19. Also, the magnet 31 is attached to the inside of the case 11. The case 11 and the base 13 may be mounted on the receiver portion of a mobile phone, etc.

The shaft 15 is rotatably inserted in the case 11 and base 13 by way of the upper bearing 17 and lower bearing 19. One end of the shaft 15 is in contact with the base 13 by way of a sliding washer 29. The sliding washer 29 reduces the friction generated between the end of the shaft 15 and the base 13, to allow smoother rotation of the shaft 15.

Onto the middle of the shaft 15 is inserted the rotor 37, which rotates as a single body with the shaft 15. The rotor 37 may be secured to the shaft 15 using adhesive, but to increase productivity and improve the durability of the rotor 37, the shaft 15, commutator 27, wound coils 41, and weight 43 may be formed as a single body using insert injection molding. A washer 21 may be inserted onto the shaft 15 to prevent the rotor 37 from becoming detached because of the rotation.

The upper bearing 17 is interposed between the case 11 and the shaft 15, and the lower bearing 19 is interposed between the base 13 and the shaft 15, to allow smoother rotation of the shaft 15. Various types of bearing may be used for the upper bearing 17 or lower bearing 19, such as a fluid bearing, hydrodynamic bearing, and oilless bearing, etc. When the upper bearing 17 is a fluid bearing, metal tape 35 may be attached at the upper center of the case 11 to prevent the dispersing of the fluid.

The shaft 15 is equipped with brushes 25 that connect with the commutator 27 of the rotor 37. The brushes 25 are secured to the base 13, and the connection with the commutator 27 allows an electric current supplied from an outside source to flow to the commutator 27. The commutator 27 rotates together with the rotor 37, while maintaining contact with the brushes 25 to supply an electric current to the wound coils 41.

The rotor 37 is inserted onto the shaft 15 and is rotated to induce vibration. The rotor 37 is composed of the hard board 47, the wound coils 41, the weight 43, and the mold 45.

The hard board 47 has the shape of a circular plate, and the wound coils 41 and the weight 43 are secured by the mold 45 to the upper surface of the hard board 47. The hard board 47 may be a printed circuit board (PCB) to which both ends of each wound coil 41 is connected.

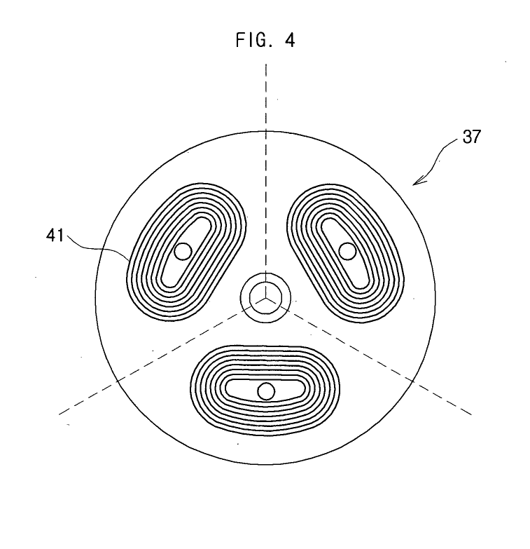

The weight 43, as illustrated in FIGS. 3 and 4, is eccentrically secured to the periphery of the rotor 37, to generate vibration by inducing eccentricity when the rotor 37 is rotated. It may be preferable for the central angle of the weight 43 to be 180° or smaller, because when the central angle exceeds 180°, the eccentricity is offset by an amount corresponding to the exceeding portions. The central angles of the wound coils 41″ in the portions where the weight 43 is arranged, as illustrated in FIG. 4, may be smaller than 120°, because the sizes of the coils 41 may be decreased in correspondence to the portion occupied by the weight 43. The weight 43 may be secured onto the hard board 47 by the mold 45 formed by insert injection molding.

To increase the eccentricity, the weight 43 may be made of a material high in specific gravity, such as osmium (specific gravity: 22.5), platinum (specific gravity: 21.45), tungsten (specific gravity: 19.3), and gold (specific gravity: 19.29), etc.

The mold 45 may be formed by insert injection molding, and may secure the wound coils 41 and the weight 43 onto the hard board 47. The mold 45 may be made of an insulating material, to act as insulation between the wound coils 41. Plastic resins, such as thermosetting resin, may be used for the mold 45 having an insulation property. For example, the mold 45 may be made from epoxy resin, cyanate esther resin, bismaleimide resin, polyimide resin, or functional-group-containing polyphenylene ether resin, by itself or as a composite of two or more resins.

There may be three wound coils 41 in intervals of 120° from the center of the rotor 37, as illustrated in FIG. 4. The number of wound coils 41 may be 3n (where n is a natural number), because when the vibration motor is a 3-phase motor, the number of wound coils 41 is also a multiple of 3. While the number of wound coils 41 in this embodiment is three, the invention is not thus limited, and it is to be appreciated that the number may also be 3n.

The three wound coils 41 may be arranged in equal intervals of 120° and may each have the same size, in order to maximize the sizes of the wound coils 41 and maximize the vibration. Since the vibration motor of this embodiment has the weight 43 positioned not on upper surface of the rotor 37 but on the lower surface, the sizes of the wound coils 41 may be increased.

The magnet 31 is secured to the inner surface of the case, and may be made of a permanent magnet such as of ferrite or neodymium, etc., in the shape of a donut. The magnetic force lines starting from the magnet 31 passes through the wound coils 41 and then return to the magnet 31, to form closed magnetic paths. While in this embodiment, the magnet 31 is attached above the rotor 37, i.e. on the inside of the case 11, the present invention is not thus limited, and it is to be appreciated that the magnet 31 may be secured to the base 13 as long as it does not inhibit the rotation of the rotor 37.

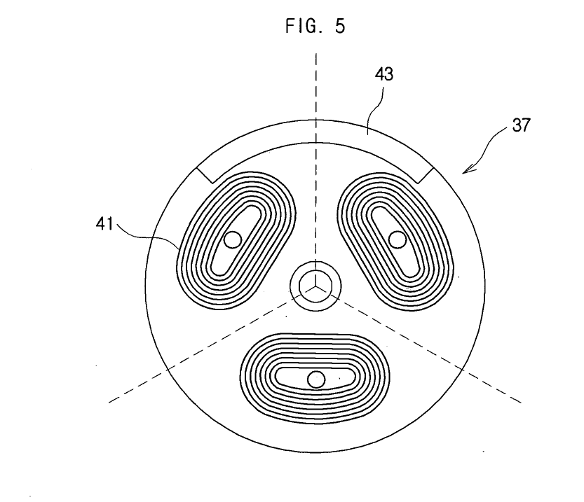

Referring to FIG. 5, the weight 43, in another embodiment of the invention, has a horizontal cross section shaped as an arc, and is secured on the reverse side of the rotor 37 along the periphery. As in the previously disclosed embodiment, the securing method may include using adhesive and/or a mold 45. It may be preferable that the central angle of the weight 43 be 180° or smaller. This is because when the central angle of the weight 43 exceeds 180°, the eccentricity is offset by an amount corresponding to the exceeding portions.

The operation of the vibration motor according to this embodiment will be described below.

As illustrated in FIG. 3, when an electric current is supplied to the brushes 25 and the commutator 27, the electric current is supplied to the wound coils 41 connected to the commutator 27, whereby an electrical field is generated around the wound coils 41. In addition, there is a magnetic field generated by the magnet 31. The electrical field and the magnetic field interact to generate an electromagnetic force according to Fleming's Left Hand Rule, by which the rotor 37 is able to rotate. Since the weight 43 is positioned eccentrically to the center of rotation of the rotor 37, the rotation of the rotor 37 induces vibration. The vibration thus generated is transferred through the shaft 15, onto which the rotor 37 is inserted, to the case 11 and base 13, so that the vibration is propagated to the exterior.

According to an aspect of the invention as set forth above, a vibration motor is provided which can increase the vibration of the motor and reduce the amount of electrical consumption during operation.

Another aspect of the invention provides a vibration motor having a rotor that can be manufactured easily.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A vibration motor comprising:
a base and a case forming an internal space;
a shaft rotatably inserted in the base and the case;
a rotor inserted onto the shaft and configured to rotate, the rotor comprising a plurality of wound coils and a commutator connected to the wound coils;
a weight attached to a lower surface of the rotor;
a brush in contact with the commutator and positioned on the base; and
a magnet facing the rotor.

2. The vibration motor of claim 1, wherein the number of the wound coils is three, and the wound coils are arranged on the rotor in intervals of about 120°.

3. The vibration motor of claim 2, wherein all of the wound coils have the same size.

4. The vibration motor of claim 1, wherein the weight has a central angle smaller than 180°.

5. The vibration motor of claim 4, wherein the weight is made of tungsten or a tungsten alloy.

6. The vibration motor of claim 1, wherein the shaft is inserted in the case and the base by way of a bearing.

7. The vibration motor of claim 1, wherein a sliding washer is positioned between an end of the shaft and the base.

8. The vibration motor of claim 1, wherein the weight has a fan-like shape.

9. The vibration motor of claim 1, wherein the weight has a horizontal cross-section shaped as an arc and is attached on the periphery of the rotor.

10. The vibration motor of claim 1, wherein the rotor further comprises a hard board, and the commutator, the shaft, the wound coils, and the weight are formed as a single body with the hard board by insert injection molding.
